(19) United States
(12) Patent Application Publication
(10) Pub. No.: US 2024/0170171 A1
(43) Pub. Date: May 23, 2024

(54) ELECTROCHEMICAL SURFACE TREATMENT APPARATUS

(71) Applicants: C-Tech Innovation Limited, Chester (GB); National Nuclear Laboratory Limited, Warrington (GB)

(72) Inventors: Robert BELL, Chester (GB); John COLLINS, Chester (GB); Luke O'BRIEN, Warrington (GB)

(21) Appl. No.: 18/551,265

(22) PCT Filed: Mar. 21, 2022
(86) PCT No.: PCT/EP2022/057389

§ 371 Date: Sep. 19, 2023

(30) Foreign Application Priority Data
Mar. 19, 2021 (GB) 2103827.8

(51) Int. Cl. G21F 9/00; G21F 9/30

(52) U.S. Cl. CPC G21F 9/004; G21F 9/30

(57) ABSTRACT

The invention provides electrochemical surface treatment apparatus (100) for the treatment of radioactively contaminated internal surfaces of a pipe (1). The apparatus (100) includes an electrode device (102). The device (102) includes an electrode (4), which, in use, is located in electrolyte liquid (2) within the pipe (1) adjacent a treatment surface (104) to be treated with a gap (106) defined between the electrode (4) and the treatment surface (104). The apparatus (100) includes a circulation arrangement (108). The electrode (4) defines an internal passage (110). In use, the circulation arrangement (108) causes a recirculating flow of electrolyte liquid (2) through the gap (106) in one direction and along the passage (110) in an opposite direction.

### BACKGROUND OF THE INVENTION

### 1. Field of the Invention

The present invention relates to electrochemical surface treatment apparatus, particularly, but not exclusively, to electrochemical surface treatment apparatus for the treatment of radioactively contaminated surfaces.

### 2. The Prior Art

Decontamination of metal surfaces is a common problem in industry, including in the nuclear industry where metal comes into contact with radionuclides and becomes contaminated. Contaminated metal may include ducting, pipework, glove boxes, storage vessels etc. Once the metallic surface has been in contact with media containing radioactive species, contaminants may become firmly associated with the surface and cannot be removed by simple rinsing or washing. This can be a result of the radioactive elements either reacting with the surface or penetrating a short way into it via physical surface features (e.g. cracks, corrosion pits etc.) or incorporation into the surface elemental matrix structure. The result is that there is radioactivity associated with the surface.

It is therefore desirable to remove radioactive contamination from the surfaces of items. Through removing the thin contaminated surface layer from the metallic item, the bulk of the materials can be re-classified to lower waste categories, thus resulting in a number of benefits including reduced radiation does to workers, and a smaller waste inventory that requires management and reduced associated costs.

Handling of contaminated material is often a challenge due to the associated radiation dose to workers and the limited hands-on access. Consequently, additional precautions and methods and facilities are required to deal with contaminated items, with the objectives of removing the contamination, minimising hazard to health, and recovering decontaminated metal for re-use via conventional recycling processes.

The first step in the treatment of contaminated metallic surfaces is the removal of any surface coatings such as grease or paint. Suitable processes may include the use of solvents to remove greases and the use of abrasive techniques such as grit blasting to remove paint. Laser ablation as described in US 2009060780 A (WESTINGHOUSE ELECTRIC GERMANY) May 3, 2009 “Device & method for the treatment and or decontamination of surfaces” or machining of surfaces may also be used. These methods are effective but are manually intensive processes that generate particulate waste and vapours and therefore present additional hazard control and containment challenges. Solvent based processes have the additional disadvantage that organic material may be introduced that subsequently contaminates the downstream processing and extraction of radionuclides.

Having removed any surface coatings, a means of removing a thin sub-surface layer from the metal is required to achieve decontamination. There are various means known as discussed below.

One method is to chemically dissolve the contaminated layer of metal, including any oxide or other deposited layer. The challenge is to dissolve this contaminated layer completely whilst at the same time dissolving only a finite and controlled amount of the uncontaminated substrate metal. Chemical reagents can be applied in combination or as part of a multi-stage process to decontaminate surfaces. Various chemical treatments are known including the use of acetic acid (hence the use of the term “pickling”), sulfuric acid and other or additional agents such as hydrochloric acid for mild steel and hydrofluoric acid for stainless steel, or hydrofluoric/nitric acid mixtures. These chemical treatments are utilised in the metals finishing industries where thermal processing of metals gives rise to an oxide surface layer which must be removed before further processing steps can be carried out. These treatments may not be preferred for use in nuclear decontamination if they are incompatible with the materials of construction of any downstream effluent treatment plants.

A limitation with the use of nitric acid as a decontamination agent is that the dissolution reaction is very slow so that relatively larger plants are required to deal with the large volumes of acid reagents required. The rate of reaction can be increased through the addition of oxidising agents such as cerium (IV), organic acids such as citric and oxalic acids, and complexing agents such as ethylenediaminetetraacetic acid. These agents can increase the rate of reaction with the surface but at the expense of creating a secondary waste liquid which is highly corrosive and cannot be handled or treated using conventional nuclear effluent treatment plants.

A different method of surface decontamination is described in U.S. Pat. No. 7,384,529 B (US ENERGY) Oct. 6, 2008 “Method for electrochemical decontamination of radioactive metal”, where a current is passed through the contaminated article using a conductive electrolyte bath. Electrochemical descaling (or “electro-pickling”) is commonly used in metals processing. This method has the significant advantage over chemical methods in that the rate of surface removal is very much greater than with chemical methods.

The practical consequence is that an electrochemical treatment requires a much smaller quantity of acid reagent that a chemical treatment. An additional advantage is that electrochemical processes are easily controllable since an electrochemical process responds immediately to the level of current passing which in turn is determined by the electrical potential applied. Electrochemical processes have the significant drawback however in that they are only effective where the geometry allows the placement of the counter-electrode close to the working piece. This is because the electric field strength between the workpiece (working electrode) and the counter-electrode decreases as the gap between the two increases. The counter-electrode is a conductive material in contact with the electrolyte. It may be formed of a single piece of material or multiple pieces.

The choice of electrical waveform for use in electro-pickling has been the subject of previous study and it has been found advantageous to combine a direct current offset to an alternating current waveform. It has been shown in US 2003075456 A (COLLINS ET AL) Apr. 24, 2003 that it is possible to descale a wide range of metals coated with oxide films more rapidly using AC waveforms with DC bias, than when using AC waveforms without DC bias. It was also shown that it can be advantageous to periodically reverse the polarity of the DC bias. Removal or cleaning of the oxide layers on the surface of metals was shown to be faster when a DC bias was applied to an AC waveform, compared to the use of AC current alone. The cleaning mechanism involves some dissolution of the contaminated layer, some undercutting where the underlying metal is dissolved, and some scrubbing action resulting from the generation of gas bubbles at the interface.

An invention disclosed in WO 2020/089610 describes an electrolytic treatment system to decontaminate the surface of a radioactively contaminated metallic workpiece that comprises at least two electrodes, each in close proximity to the surface but not in direct electrical contact with it. An electrolyte solution is present in the space between the workpiece surface and the electrodes. The electrodes may be moved in relation to the surface. The electrodes are connected to an alternating current source, and when the system is in use current flows between the electrodes and the electrolyte solution and though the metallic workpiece.

This is useful as a means of treating the interior surfaces of radioactively contaminated metallic pipes vessels or other structures. The contaminated interior surface is electrochemically dissolved into the electrolyte solution. The electrolyte solution is subsequently processed to remove the radioactive contamination.

Nitric acid is commonly used as an electrolyte for this process because of its widespread use in the nuclear industry, but other acids and reagents may also be used.

Devices suitable for carrying out this electrochemical surface treatment process are able to move relative to the contaminated surface, so that an extended area may be treated. The movement may be for example across the interior surface of a vessel or the exterior surface of objects or pipework contained within vessels, or along the interior surface of a pipe.

In order to attain a suitably rapid rate of surface treatment it is advantageous to use a counter-electrode of certain minimum dimensions, corresponding to equivalent dimensions of working electrode (the workpiece being treated). A larger surface area of working electrode is advantageous because this permits a greater electrical current to be passed for a given current density. The quantity of material removed from the surface is proportional to the charge passed and so a greater current increases the rate of treatment.

It is preferential for the counter-electrode to be maintained at a constant distance from the workpiece, and for the two to be parallel. This allows for a constant current density across the electrode, and a correspondingly even treatment.

It is preferable also that the distance between the working electrode and the counter-electrode is kept to the minimum consistent with avoiding direct physical and electrical contact between the two. This is because the electrolyte liquid has a finite electrical resistance which causes a voltage drop across the electrolyte and power losses due to the resistive heating of the liquid.

A problem with known devices for this purpose is that the electrochemical action generates gases which can interfere with the process. Gas generation is the result of the electrochemical breakdown of water and other chemical species in solution. Hydrogen, oxygen, nitrogen oxides and other gases may be generated. Gas generation can be reduced by reducing the current density and rate of electrochemical treatment, but for a practically useful electrochemical treatment rate, gas generation is unavoidable. Gas bubbles and pockets can accumulate at the surfaces of the working and counter-electrodes, and in the space between them, with the result that the electrical current path is obstructed or “blinded”. This results in a reduced and uneven surface treatment.

For system operating inside a vessel or pipe gas build-up can be avoided by continually renewing the electrolyte in the vicinity of the treatment device by means of a significant flow of electrolyte. If the rate of flow of electrolyte is sufficient then gas generated at the electrode or treatment surface is entrained in the liquid flow and transported away from the electrode. Whilst possible in principle this approach is not desirable in practice because of the added complexity and high volume of electrolyte required increasing the volume of waste solution and risk of having to continually supply electrolyte whilst the treatment is in progress. It is preferable that the treatment be carried out with the electrolyte contained within a filled pipe or vessel and without any external supply or handling of electrolyte during the treatment time.

This invention relates to the treatment of nuclear contamination, especially its removal from surfaces.

In this specification any reference to surfaces or workpieces or items or articles or objects to be treated refers to the surface of metallic articles and items including but not limited to pipes, vessels, tubes, ducts, boxes, tanks, flasks, cylinders, shafts, and other structural elements.

### SUMMARY OF THE INVENTION

According to a first aspect of the present invention, there is provided electrochemical surface treatment apparatus for the treatment of radioactively contaminated internal surfaces of a pipe, the apparatus including an electrode device, the device including an electrode, which, in use, is located in electrolyte liquid within the pipe adjacent a treatment surface to be treated with a gap defined between the electrode and the treatment surface, the apparatus including a circulation arrangement, the electrode defining an internal passage, wherein, in use, the circulation arrangement causes a recirculating flow of electrolyte liquid through the gap in one direction and along the passage in an opposite direction.

Possibly, the electrode is annular. Possibly, the passage is a central passage therethrough.

Possibly, the passage is open at each end.

Possibly, the passage is closed at or towards one end. The electrode may define a plurality of side holes which permit communication between the passage and the gap. In use, electrolyte liquid may circulate along the gap in one direction, along the passage in an opposite direction and through the side holes back to the gap.

Possibly, the electrode comprises a working surface which is circular in cross-section.

Possibly, the device includes the circulation arrangement.

Possibly, the circulation arrangement includes a pump, which may include an inlet and an outlet.

Possibly, the pump is partly or wholly located in the passage.

Possibly, the pump is electrically or pneumatically powered from a power supply connected to the device, possibly by means of an umbilical cable.

Possibly, the power for the pump is taken from the electrode power supply.

Possibly, the operation of the pump is intermittent or pulsed rather than continuous.

Possibly, the circulation arrangement includes liquid or gas powered eductors.

Possibly, the device includes a vibrator to provide vibration of the electrode, which may be mechanical or ultrasonic.

Possibly, the apparatus includes a plurality of the electrode devices, which may vary in size, shape and spacing.

Possibly, the or each device includes two electrodes of opposite polarity.

Possibly, in use, the electrodes are separated by a distance such that the electrical resistance from one electrode to the other through the electrolyte liquid is significantly greater than the electrical resistance of a path from one electrode to the treatment surface, along the treatment surface, and from the treatment surface to the second electrode.

Possibly, the electrode(s) comprises a counter electrode and the treatment surface comprises a working electrode.

Possibly, the apparatus includes a power supply to the electrodes.

Possibly, the power supply comprises a DC supply. Possibly, in use the electrodes are alternatingly polarised as cathodes and anodes by the DC supply.

Possibly, the power supply comprises a DC-biased AC supply. Possibly, in use the electrodes are alternatingly polarised as cathodes and anodes by the DC-biased AC supply, which may have a frequency of at least 1 Hz and at most 1000 Hz.

Possibly, the or each electrode includes an electrode surface which in use is located at a constant distance from the treatment surface.

Possibly, the electrode surface has a minimum surface dimension in length or width which is greater than the gap.

Possibly, the flow extends over substantially the whole of the electrode surface.

Possibly, in use, the apparatus is located in a pipe in which flow of electrolyte along the pipe is substantially prevented or constrained so that there is no net flow of electrolyte along the pipe during treatment. Possibly, one end of the pipe is sealed.

Possibly, the recirculating flow circulates in the locality of the electrode.

Possibly, there is no direct contact between the apparatus and the internal surface being treated.

According to a second aspect of the present invention, there is provided a method of electrochemically treating a surface, the method including providing electrochemical surface treatment apparatus for the treatment of radioactively contaminated internal surfaces of a pipe, the apparatus including an electrode device, the device including an electrode, which, in use, is located in electrolyte liquid within the pipe adjacent a treatment surface to be treated with a gap defined between the electrode and the treatment surface, the apparatus including a circulation arrangement, the electrode defining an internal passage, wherein, in use, the circulation arrangement causes a recirculating flow of electrolyte liquid through the gap in one direction and along the passage in an opposite direction.

Possibly, the apparatus includes any of the features shown or described in any of the preceding statements, following description or accompanying drawings. Possibly, the method includes any of the steps shown or described in any of the preceding statements, following description or accompanying drawings.

### BRIEF DESCRIPTION OF THE DRAWINGS

Embodiments of the present invention will now be described, by way of example only, and with reference to the accompanying drawings, in which:

FIG. 1 is a side schematic view of electrochemical surface treatment apparatus located in a pipe; and

FIG. 2 is a side schematic view of another electrochemical surface treatment apparatus located in a pipe.

In the drawings, where multiple instances of the same or similar features exist, only a representative one or some of the instances of the features may have been provided with numeric references for clarity.

### DETAILED DESCRIPTION OF THE PREFERRED EMBODIMENTS

The invention is a novel design of electrolytic treatment device for use within a metallic pipe or vessel or enclosed workpiece that contains an electrolyte solution. A counter-electrode is positioned parallel to the working electrode such that the gap between the counter-electrode and the working electrode is smaller than both the width and length of the counter-electrode surface that is parallel to the working electrode. A pump is provided as part of the treatment device that pumps electrolyte through the gap between the counter and working electrodes, at a rate sufficient to displace any pockets of gas. Supply of liquid for the pump is drawn from the immediate vicinity of the device. It is sufficient that this flow of electrolyte happens only in the vicinity of the device, its electrodes, and the surface being electrochemically treated, and does not need to happen elsewhere. In this way the interior surface of the pipe or vessel or other workpiece can be evenly treated, even when there exist pockets of gas that would otherwise impede the electrochemical action in their vicinity. There is no requirement for a remote supply of electrolyte, and it is only necessary that the vessel or pipe contain sufficient volume of electrolyte such that the pump draws liquid continuously.

An embodiment of the invention suitable for the treatment of the interior surface of a vessel or exterior surface of a pipe of other surface contained within a vessel has one or more electrodes shaped such that the surface of the electrodes is maintained at a uniform distance from the surface being treated. An electric current is passed from the electrodes and through the electrolyte solution and causes the electrochemical dissolution of metal from the surface of the workpiece. There may be one electrode and a return electrical path through the pipe and power supply, or there may be two or more similar electrodes so that the electrical current travels along only the small distance between the treatment zones of the two or more electrodes. A pump is located within the device, and electrolyte is pumped from a point within or near to the treatment device and through the gap between the electrode surfaces. In this way no gas build-up occurs in the vicinity of the electrodes. In the case of multiple electrodes, the liquid circulation arrangements may be varied. Each electrode may be provided with its own pump, or two or more electrodes may be provided with a single pump only. The pumping action may be continuous or pulsed. The pump may be powered electrically or hydraulically or pneumatically. Other methods of providing the necessary liquid movement may also be suitable including liquid or gas powered eductors, and reciprocating paddle or baffle arrangements. Ultrasonic or mechanical vibration of the counter-electrode may assist in the removal of gas bubbles by the liquid flow.

A preferred embodiment of the invention suitable to treat the interior surface of a pipe has one or more electrodes that are of cylindrical annular form. An electric current is passed from the electrodes and through the electrolyte solution and causes the electrochemical dissolution of metal from the interior surface of the pipe. The electrode is maintained centrally in the pipe. There may be one electrode and a return electrical path through the pipe and power supply, or there may be two or more similar electrodes so that the electrical current travels along only the small distance between the treatment zones of the two or more electrodes. A pump is located within the device, and electrolyte is pumped from the central axis of the pipe at a point within or near to the treatment device and through the annular gap between the electrode outer surface and the pipe interior surface. In this way no gas build-up occurs in the vicinity of the electrodes. For the purpose of carrying out the operation one end of the pipe is sealed, the other end open. The pumping action does not cause a net flow of liquid along the pipe, only a circulation of liquid in the vicinity of the electrode. The pumping action may be continuous or pulsed. The pump may be powered electrically or hydraulically or pneumatically. In the case of multiple electrodes, the liquid circulation arrangements may be varied. Each electrode may be provided with its own pump, or two or more electrodes may be provided with a single pump only.

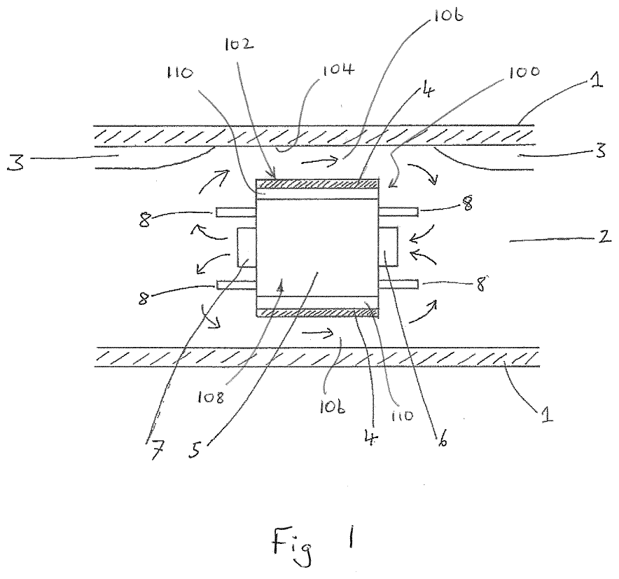

Referring to FIG. 1, the invention provides electrochemical surface treatment apparatus 100 for the treatment of radioactively contaminated internal surfaces of a pipe 1.

The apparatus 100 includes an electrode device 102. The device 102 includes an electrode 4, which, in use, is located in electrolyte liquid 2 within the pipe 1 adjacent a treatment surface 104 to be treated with a gap 106 defined between the electrode 4 and the treatment surface 104.

The apparatus 100 includes a circulation arrangement 108. The electrode 4 defines an internal passage 110. In use, the circulation arrangement 108 causes a recirculating flow of electrolyte liquid 2 through the gap 106 in one direction and along the passage 110 in an opposite direction.

In the example shown, the electrode 4 is annular, and the passage 110 is a central passage therethrough.

In FIG. 1, the passage 110 is open at each end.

The electrode comprises a working surface which is circular in cross-section.

The device includes the circulation arrangement.

The circulation arrangement includes a pump, which may include an inlet and an outlet.

In the example shown, the pump is wholly located in the passage. In other embodiments, the pump could be partly located in the passage.

The pump is electrically or pneumatically powered from a power supply connected to the device, by means of an umbilical cable.

The power for the pump could be taken from the electrode power supply.

The operation of the pump could be intermittent or pulsed rather than continuous.

In other embodiments, the circulation arrangement 108 could include liquid or gas powered eductors.

The device could include a vibrator to provide vibration of the electrode, which could be mechanical or ultrasonic.

In some embodiments, the apparatus could include a plurality of the electrode devices, which could vary in size, shape and spacing.

The or each device could include two electrodes of opposite polarity.

In use, the electrodes could be separated by a distance such that the electrical resistance from one electrode to the other through the electrolyte liquid is significantly greater than the electrical resistance of a path from one electrode to the treatment surface, along the treatment surface, and from the treatment surface to the second electrode.

The electrode(s) could comprise a counter electrode and the treatment surface could comprise a working electrode.

The apparatus could include a power supply to the electrodes.

The power supply could comprise a DC supply, and in use the electrodes could be alternatingly polarised as cathodes and anodes by the DC supply.

Alternatively, the power supply could comprise a DC-biased AC supply, and in use the electrodes could be alternatingly polarised as cathodes and anodes by the DC-biased AC supply, which could have a frequency of at least 1 Hz and at most 1000 Hz.

The or each electrode could include an electrode surface which in use is located at a constant distance from the treatment surface.

The electrode surface could have a minimum surface dimension in length or width which is greater than the gap.

In use, the flow extends over substantially the whole of the electrode surface.

In use, the apparatus is located in a pipe in which flow of electrolyte along the pipe is substantially prevented or constrained so that there is no net flow of electrolyte along the pipe during treatment. For example, one end of the pipe could be sealed.

The recirculating flow circulates in the locality of the electrode.

FIG. 1 is a sectional view along a pipe of approximately circular cross-section, 1. The pipe is filled with an electrolyte liquid 2, and there are pockets of gas collected at the uppermost parts of the pipe, 3. Electrochemical surface treatment apparatus includes an electrode device, which is located in the centre of the pipe. The device includes an electrode and a liquid circulation arrangement.

Other parts of the apparatus including a second electrode device, guidance devices, structural elements, and umbilical connection, are omitted for clarity. Mechanical and electrical elements 8 make suitable connections to the other parts of the equipment not shown.

In the example shown, the electrode comprises an annular electrode 4 is connected to a remote power source via an umbilical cable. The circulation arrangement includes a pump 5 which includes an inlet 6, and outlet, 7. The electrode defines a central passage.

The inside of the annular electrode is blocked to liquid passage other than through the pump. The inlet 6 is positioned approximately along the central axis of the pipe.

Liquid is drawn into the inlet 6, and is pumped out of the outlet 7, passing through the gap between the outside of the annular electrode and the inside surface of the pipe.

The direction of liquid flow is shown by the arrows. The pressure and flow of liquid through the gap between the electrode and pipe surface is sufficient to displace any gas pockets there, so that the electrochemical treatment is distributed evenly around the circumference of the pipe surface.

Surprisingly, the Applicants have found that an even treatment of vessel interior surface or pipe interior does not require the whole of the vessel or pipe to be completely filled with liquid to the exclusion of gas pockets, and that a localised circulation of electrolyte in the vicinity of the electrode is sufficient to avoid the problems associated with gas build-up, and that no external pumping and de-gassing of the electrolyte solution is necessary.

This invention utilises this finding by providing surface treatment apparatus which maintains a flow of electrolyte between the working and counter-electrodes sufficient to displace gas bubbles generated during the treatment.

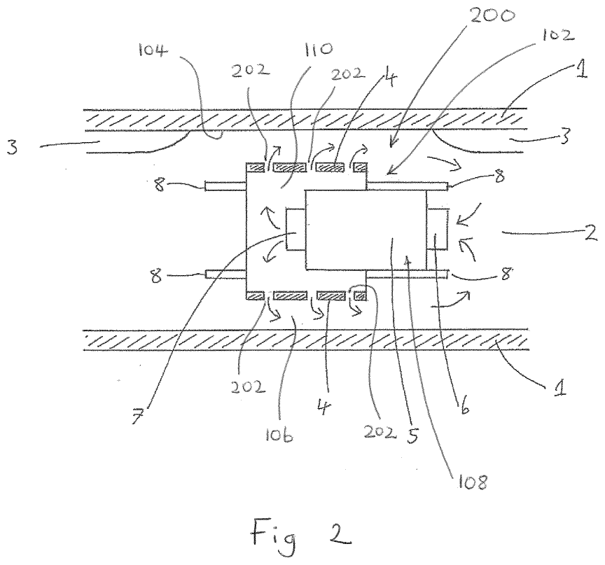

FIG. 2 shows another embodiment of the invention, many features of which are similar to those already described in relation to the embodiment of FIG. 1. Therefore, for the sake of brevity, the following embodiment will only be described in so far as it differs from the embodiment already described. Where features are the same or similar, the same reference numerals have been used and the features will not be described again.

FIG. 2 shows a different arrangement of the liquid flow pattern, but achieving the same objective. The drawing again shows a sectional view through a pipe of approximately circular cross-section, which is again filled with electrolyte liquid 2, and with gas pockets, 3, in the upper part of the pipe.

In this example, apparatus 200 includes an electrode 4 which defines a passage 110 which is closed at or towards one end. The electrode 4 defines a plurality of side holes 202 which permit communication between the passage 110 and the gap 106. In use, electrolyte liquid 2 circulates along the gap 106 in one direction, along the passage 110 in an opposite direction and through the side holes 202 back to the gap 106.

Liquid flow direction is shown by the arrows. The annular electrode is sealed against liquid flow out of its ends, other than through the pump, and liquid may only exit through the holes around its surface. The flow of liquid through the holes in the electrode and along the gap between the electrode is such that gas pockets are excluded from this region. Elements 8 comprise connectors to parts of the device not shown.

Various other modifications could be made without departing from the scope of the invention. The apparatus could be of any suitable size and shape, and could be formed of any suitable material (within the scope of the specific definitions herein).

Any of the features or steps of any of the embodiments shown or described could be combined in any suitable way, within the scope of the overall disclosure of this document.

What is claimed is:

1. Electrochemical surface treatment apparatus for the treatment of radioactively contaminated internal surfaces of a pipe, the apparatus including an electrode device, the device including an electrode, which, in use, is located in electrolyte liquid within the pipe adjacent a treatment surface to be treated with a gap defined between the electrode and the treatment surface, the apparatus including a circulation arrangement,
the electrode defining an internal passage,
wherein, in use, the circulation arrangement causes a recirculating flow of electrolyte liquid through the gap in one direction and along the passage in an opposite direction.

2. The apparatus according to claim 1, in which the electrode is annular and the passage is a central passage therethrough.

3. The apparatus according to claim 1, in which the passage is open at each end.

4. The apparatus according to claim 1, in which the passage is closed at or towards one end, the electrode defines a plurality of side holes which permit communication between the passage and the gap, and in use, electrolyte liquid circulates along the gap in one direction, along the passage in an opposite direction and through the side holes back to the gap.

5. The apparatus according to claim 1, in which the electrode has a working surface which is circular in cross-section.

6. The apparatus according to claim 1, in which the device includes the circulation arrangement.

7. The apparatus according to claim 1, in which the circulation arrangement includes a pump, and the pump includes an inlet and an outlet.

8. The apparatus according to claim 1, in which the circulation arrangement includes a pump, the pump includes an inlet and an outlet, and the pump is partly or wholly located in the passage.

9. The apparatus according to claim 8, in which the pump is electrically or pneumatically powered from a power supply connected to the device by means of an umbilical cable.

10. The apparatus according to claim 8, in which the power for the pump is taken from the electrode power supply.

11. The apparatus according to claim 8, in which the operation of the pump is intermittent or pulsed rather than continuous.

12. The apparatus according to claim 1, in which the circulation arrangement includes liquid or gas powered eductors.

13. The apparatus according to any of the preceding claims claim 1, in which the device includes a vibrator to provide vibration of the electrode, which may be mechanical or ultrasonic.

14. The apparatus according to claim 1, in which the apparatus includes a plurality of the electrode devices, which may vary in size, shape and spacing.

15. The apparatus according to claim 1, in which the or each device includes two electrodes of opposite polarity.

16. The apparatus according to claim 15, in which in use, the electrodes are separated by a distance such that the electrical resistance from one electrode to the other through the electrolyte liquid is significantly greater than the electrical resistance of a path from one electrode to the treatment surface, along the treatment surface, and from the treatment surface to the second electrode.

17. The apparatus according to claim 1, in which the electrode(s) comprises a counter electrode and the treatment surface comprises a working electrode, and the apparatus includes a power supply to the electrodes.

18. The apparatus according to claim 17, in which the power supply comprises a DC supply, and in use the electrodes are alternatingly polarised as cathodes and anodes by the DC supply.

19. The apparatus according to claim 17, in which the power supply comprises a DC-biased AC supply, and in use the electrodes are alternatingly polarised as cathodes and anodes by the DC-biased AC supply, which may have a frequency of at least 1 Hz and at most 1000 Hz.

20. The apparatus according to claim 1, in which the flow of electrolyte liquid is sufficient to displace gas bubbles generated in use.

21-25. (canceled)
